(19) United States
(12) Patent Application Publication
(10) Pub. No.: US 2006/0064603 A1
(43) Pub. Date: Mar. 23, 2006

(54) High security memory system

(75) Inventors: Sandeep Relan, Bangalore (IN); Brajabandhu Mishra, Bangalore (IN); Rajendra Khare, Bangalore (IN)

Correspondence Address: MCANDREWS HELD & MALLOY, LTD, 500 WEST MADISON STREET, SUITE 3400, CHICAGO, IL, 60661, US

(73) Assignee: Broadcom Corporation

(21) Appl. No.: 10/945,596

(22) Filed: Sep. 21, 2004

(51) Int. Cl. G06F 12/14

(52) U.S. Cl. 713/193

(57) ABSTRACT

Presented herein are systems, methods, and apparatus for a high security memory system. In one embodiment, there is presented a memory system for storing and securing data. The memory system comprises a media, a first circuit, and a second circuit. The media stores the data. The first circuit detects a condition. The second circuit disables access to the data, after detection of the condition.

### RELATED APPLICATIONS

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

As computers become more prevalent with different types of businesses and government agencies, such institutions must be increasingly on guard to protect information contained on such computers. The computers include memory systems, typically hard discs, that can store highly confidential information, such as corporate secrets, trade secrets, legally privileged information, and even classified information. Access to the foregoing information by unauthorized persons for illegitimate uses can place the institution at a severe disadvantage. In cases where the information is classified, access to the information by unauthorized persons can have national security implications.

Unauthorized users can access the confidential information, either remotely or directly. Remote unauthorized access involves an access over a communication network, where the unauthorized user transfers the information over the communication network. This is often referred to as “hacking”. Direct access is where the unauthorized user has direct physical access to the memory system.

Remote unauthorized access can be effectively prevented by a number of measures, including, firewalls, password authentication, and even disconnecting access by any communication network that is not physically secured. Direct unauthorized access can be prevented by physically securing the premises surrounding the computer system.

However, laptop, palm top computers, and other portable computing devices such as personal digital assistants (PDAs), or even mobile phones make physically securing the premises surrounding the computer system difficult. These portable computing devices allow the authorized users to carry them while traveling. This can place the computer, and the confidential information contained therein, in an environment that is not secured.

While the portable computing device is in such an environment, an unauthorized user can directly access the confidential information by stealing it. Alternatively, the unauthorized user can remove the memory system. In another alternative, the unauthorized user can take custody of the computer, copy the memory system while the computer is in their custody, and return the computer. In any of the following ways, the unauthorized user now has access to the confidential information.

One way to avoid the foregoing is to encrypt the data stored in the memory. Thus, even if the unauthorized user has physical custody of the memory, the unauthorized user may not be able to discern any useful information. Another method used to avoid the foregoing is for the institution that bears the information to establish strict guidelines on the usage of laptops/palm tops.

However, increasingly sophisticated computers have been able to decrypt encrypted data, by finding out the encryption key and encryption algorithm through software. Additionally, unauthorized users can obtain encryption keys by other means, such as observing an authorized user type the encryption key during legitimate use.

Strict guidelines governing the use of laptops/palm tops are not always effective. For example, the Pentagon has reported several missing laptops, despite establishment of criminal penalties for removing the laptops from the secure environment. In another case, hard discs storing confidential user account information inadvertently wound up being sold on-line. The guidelines also unduly restrict legitimate use and can defeat the purpose of purchasing a portable computing device.

Further limitations and disadvantages of conventional and traditional systems will become apparent to one of skill in the art through-comparison of such systems with the invention as set forth in the remainder of the present application with reference to the drawings.

### BRIEF SUMMARY OF THE INVENTION

Presented herein are systems, methods, and apparatus for a high security memory system.

In one embodiment, there is presented a memory system for storing and securing data. The memory system comprises a media, a first circuit, and a second circuit. The media stores the data. The first circuit detects a condition. The second circuit disables access to the data, after detection of the condition.

In another embodiment, there is presented a method for protecting data stored on media. The method comprises detecting a condition; and preventing access to the data, after detecting the condition.

In another embodiment, there is presented a computer system for processing data. The computer system comprises a power distribution circuit, a processor, and a hard disc drive. The hard disc is connected to the processor and the power distribution circuit. The hard disc drive comprises media, a motor, an arm, a first circuit, and a second circuit. The motor is connected to the media. The arm is located proximately to the media. The first circuit is operable to detect a condition. The second circuit is connected to the first circuit, the power supply, and at least a portion of the hard disc. The second circuit selectively prevents or allows distribution of power from the power distribution circuit, based on detection of the condition.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a block diagram of a memory system in accordance with an embodiment of the present invention;

FIG. 2 is a block diagram of an exemplary portable computer system in accordance with an embodiment of the present invention;

FIG. 3 is a block diagram of a global positioning system secured hard disc drive in accordance with an embodiment of the present invention;

FIG. 4A is a block diagram describing the second circuit in accordance with an embodiment of the present invention;

FIG. 4B is a block diagram describing the second circuit in accordance with another embodiment of the present invention;

FIG. 5 is a flow diagram for securing the memory system with global positioning in accordance with an embodiment of the present invention; and

FIG. 6 is a block diagram describing a mobile phone in accordance with an embodiment of the present invention.

### DETAILED DESCRIPTION OF THE INVENTION

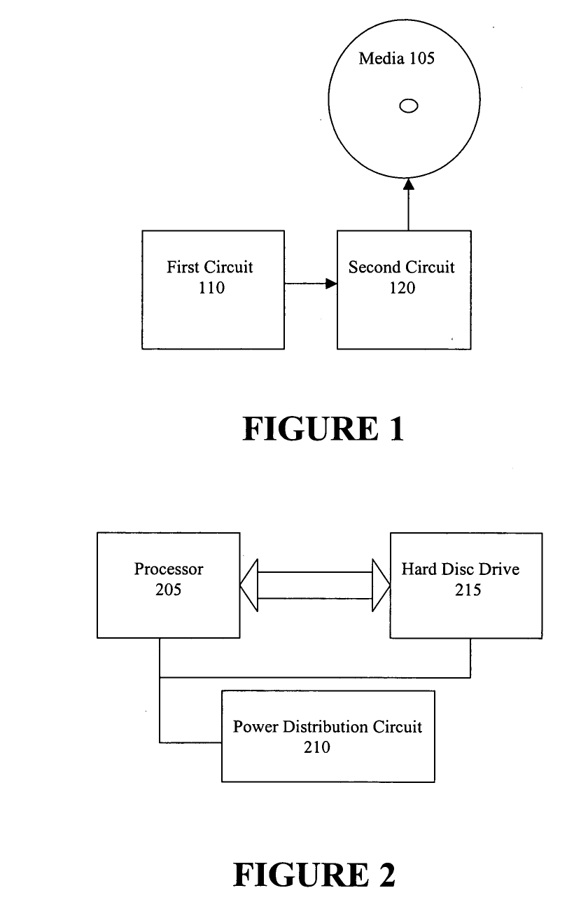

Referring now to FIG. 1, there is illustrated a block diagram of a memory system for storing and securing data in accordance with an embodiment of the present invention. The memory system comprises a media 105, a first circuit 110, and second circuit 120.

The media 105 stores the data. The media can comprise a variety of non-volatile memory types, such as hard disc platters, floppy disc media, etc. The data stored on the media can include data that is to be protected against access by unauthorized users.

The first circuit 110 is capable of detecting a condition. The condition can be a condition that is indicative of physical custody of the memory system by an unauthorized user, or other breach of security. For example, the first circuit 110 can detect that the memory system is outside a predetermined region. Alternatively, the condition can be based on the relative distance between the memory system and an authorized user. The relative distance between the authorized user can be determined by, for example, an infrared or radio signal based distance range check using a local transmitter, or a GPS system that determines the location of both the memory system and the authorized user. The condition can also be based on additional criteria, such as, but not limited to different types of user authentications, and emergency warning signals sent by the user or a centralized security control system etc. For example, in case of attack on Pentagon, a central security authority can activate an emergency warning signal to disable all accesses to pre-selected memory systems containing sensitive data.

The predetermined region is preferably a region that is physically secured by either the authorized user, or the institution, such as a corporate campus, or building. For example, where the media 105 stores classified information that is sensitive to national security, the predetermined region can comprise the Pentagon.

The first circuit 110 can detect that the memory system is outside the predetermined region in a number of ways. For example, the first circuit 110 can comprise a receiver that receives a particular signal from a transmitter. When the memory system is taken beyond a certain range from the transmitter, the receiver does not detect the transmitted signal. In such a case, the range of the transmitter can define the predetermined region.

Alternatively, the first circuit 110 can detect the presence of a disabling signal transmitted by the user. For example, if an authorized user discovers that the memory system is missing or unaccounted for, the authorized user can transmit a disabling signal. The first circuit 110 can detect the presence of the disabling signal.

Alternatively, the first circuit 110 can detect the location of the memory system and determine if it is outside the predetermined region. For example, the first circuit 110 can comprise a global positioning system (GPS) equipped circuit. The GPS equipped circuit can communicate via radio signals with a global positioning satellite to determined the location of the memory system. The first circuit 110 can then determine whether the location of the memory system is within or outside the predetermined region.

The second circuit 115 disables access to the data stored in the media 105, when the first circuit 110 detects the condition. The second circuit 115 can disable access to the data stored in the media 105 in a number of ways.

In one embodiment, the second circuit 115 can inhibit the flow of power from an external power distribution circuit to various portions of the memory system. For example, some memory systems, such as hard discs, include a motor for rotating the media, and an arm for reading and writing the data stored on the media. The second circuit 115 can comprise a relay that inhibits the flow of power to the motor or arm, when the first circuit detects the condition.

Alternatively, the second circuit 115 can electronically destroy the data stored on the media 105. For example, the second circuit 115 can comprise a controller, such as a processor, that either formats the media 105 or overwrites the data stored on the media 105, responsive to the first circuit detecting the condition. In either case, the second circuit 115 destroys the data stored on the media, making the data unreadable.

In another embodiment, the second circuit 115 can destroy the media 105. The second circuit 115 can comprise, for example, a heating coil. Responsive to the first circuit 110 detecting the condition, the heating coil can elevate the temperature of the media 105, thereby destroying it.

Referring now to FIG. 2, there is illustrated a block diagram describing a computer system 200 in accordance with an embodiment of the present invention. The computer system 200 comprises a processor 205, a power distribution circuit 210, and a hard disc drive 215. The processor 205 and the hard disc drive 215 are connected by a bus.

The computer system 200 preferably comprises a portable computer system, known as a laptop, or a hand-held computer system, known as a palm top, but can also comprise a stationary computer system, known as a desk top. Where the computer system 200 comprises a laptop or a palm top, the computer system 200 may have integrated therein, input and output devices, such as, for example, a display, keyboard, mouse, speaker and microphone.

The hard disc drive 215 can store a variety of data. An authorized user can access the data stored on the hard disc drive 215 by commanding the processor 205 to perform either read or write transactions, via the input devices. The processor 205 engages in a read/write transaction with the hard disc drive 215, via the bus. The data may comprise information that is to be protected from access by an unauthorized user.

The hard disc drive 215 is connected to, and thereby forms a portion of the computer system 200. The hard disc drive 215 can also be removable and connected to a form a portion of another computer system 200. The hard disc drive 215 is generally inserted into a slot in the computer system 200 that holds the hard disc drive 215 in place. The slot also maintains a connection between the hard disc drive 215 and the processor 205 and the power distribution circuit 210.

The power distribution circuit 210 is connectable to a power supply. The power supply can comprise either a plug outlet or a battery. The power distribution circuit 210 distributes power to the processor 205 and the hard disc drive 215.

In the case where the computer system 200 is in the physical custody of an unauthorized user, the unauthorized user may be prevented from accessing the data stored on the hard disc drive. The hard disc drive 215 is operable to detect a certain condition, and, where the condition is detected, the hard disc drive 215 prevents access by the processor 205 to the data stored therein.

The condition is can be indicative of physical custody of the computer system by an unauthorized user, or other breach of security. For example, the condition can be that the computer system 200 is located outside a predetermined region.

The hard disc drive 215 can prevent access to the data stored thereon by the processor 205 in a number of different ways. For example, the hard disc drive 215 can disconnect a portion of the hard disc drive 215 from the power supply. Alternatively, the hard disc drive 215 can automatically format itself, or overwrite the data stored thereon. The hard disc drive 215 will now be described.

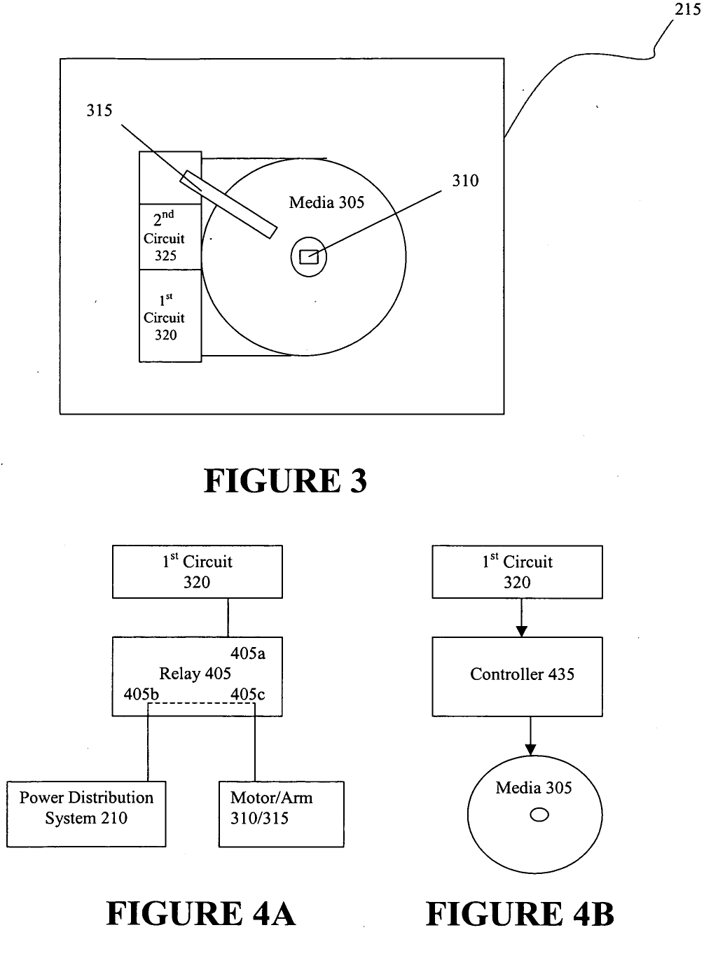

Referring now to FIG. 3, there is illustrated a block diagram describing a hard disc drive 215 in accordance with an embodiment of the present invention. The hard disc drive 215 comprises a media 305, a motor 310, an arm 315, a first circuit 320, and a second circuit 325.

The media 305 can store a substantial amount of data comprising a wide variety of information. A processor 205 accesses the data stored on the media 305 by transmitting a read/write request to the hard disc drive 215. Responsive to receiving the read/write request, the hard disc drive 215 seeks the data from the appropriate location or address in the media 305.

When the hard disc drive 215 seeks the data from the appropriate location or address in the media 305, the motor 310 rotates the media 305. The arm 315 examines the media 305 while the motor 310 rotates the media 305. When the arm 315 finds the appropriate location in the media 305, the hard disc drive 215 provides the data stored therein to the processor 205 in the case of a read transaction. The hard disc drive 215 overwrites the data stored therein with the data provided by the processor 205 in the case of a write transaction.

The hard disc drive 215 can prevent access to the data stored thereon by the processor 205 in a number of different ways. The first circuit 320 is capable of detecting a condition. The condition can be a condition that is indicative of physical custody of the memory system by an unauthorized user, or other breach of security. For example, the first circuit 320 can detect that the memory system is outside a predetermined region.

The first circuit 320 can detect that the memory system is outside the predetermined region in a number of ways. For example, the first circuit 320 can comprise a receiver that receives a particular signal from a transmitter. When the memory system is taken beyond a certain range from the transmitter, the receiver does not detect the transmitted signal. In such a case, the range of the transmitter can define the predetermined region.

Alternatively, the first circuit 320 can detect the presence of a disabling signal transmitted by the user. For example, if an authorized user discovers that the memory system is missing or unaccounted for, the authorized user can transmit a disabling signal. The first circuit 320 can detect the presence of the disabling signal.

Alternatively, the first circuit 320 can detect the location of the memory system and determine if it is outside the predetermined region. For example, the first circuit 320 can comprise a global positioning system (GPS) equipped circuit. The GPS equipped circuit can communicate via radio signals with a global positioning satellite to determined the location of the memory system. The first circuit 320 can then determine whether the location of the memory system is within or outside the predetermined region.

The second circuit 325 disables access to the data stored in the media 305, when the first circuit 320 detects the condition. The second circuit 325 can disable access to the data stored in the media 305 in a number of ways.

It is noted that the media 305, motor 310, and arm 315 of hard disc drives 215 are typically stored in a casing. Opening of the casing in most circumstances causes severe damage to the media 305. In a representative embodiment, the first circuit 320 and the second circuit 325 are also within the casing. Placing the first circuit 320 and the second circuit 325 within the casing makes it difficult to remove or tamper with the first circuit 320 and second circuit 325 without destroying the data.

In one embodiment, the second circuit 325 can inhibit the flow of power from an external power distribution circuit to various portions of the memory system. For example, some memory systems, such as hard discs, include a motor for rotating the media, and an arm for reading the data stored on the media. The second circuit 325 can comprise a relay that inhibits the flow of power to the motor and/or arm, when the first circuit detects the condition.

Referring now to FIG. 4A there is illustrated a block diagram describing the second circuit 325 in accordance with an embodiment of the present invention. The second circuit 325 comprises a relay 405. The relay 405 controls an electrical connection between the power distribution circuit 210 and a portion of the hard disc drive 215, e.g., the motor 305 and/or the arm 310.

The relay 405 can comprise three terminals—a first terminal 405a connected to the power distribution circuit 210, a second terminal 405b connected to either the motor 310 and/or arm 315, and the third terminal 405c connected to the first circuit 320. When the first circuit 320 detects the condition, the first circuit 320 can set a control signal. The control signal can be one of a positive voltage, e.g., 5 V, corresponding to a logical high signal, or a low positive voltage, e.g. voltage greater than 0 V and less than 0.5 V, corresponding to a logical low signal, a electrical pulse, an edge from higher positive voltage e.g. 5 V to lower positive voltage e.g. 0.5 V, an edge from lower positive voltage e.g, 0.5 V to higher positive voltage e.g. 5 V, one or more bits with a particular sequence transmitted in electrical form etc. When the first circuit 320 does not detect the condition, the first circuit 320 can send a zero voltage signal.

The relay 405 maintains the connection between the first terminal 405a and the second terminal 420b, where the voltage at the third terminal is less than a certain threshold (indicating that the first circuit has not detected the condition). When the voltage at the third terminal 405c exceeds the threshold (indicating that the first circuit has detected the condition), the relay 405 opens the connection between the first and second terminals 405a, 405b. Opening the connection inhibits power to the motor 310 and/or arm 315. The 2^{nd} circuit 325 may have a electronic circuit before the relay which converts the control signal transmitted by the 1^{st} circuit 320 to the input desired by the relay 405.

Alternatively, the second circuit 325 can electronically destroy the data stored on the media 305. For example, the second circuit 325 can comprise a controller, such as a processor, that either formats the media 305 or overwrites the data stored on the media 305, responsive to the first circuit detecting the condition. In either case, the second circuit 325 destroys the data stored on the media, making the data unreadable.

Referring now to FIG. 4B, there is illustrated a block diagram describing the second circuit 325 in accordance with another embodiment of the present invention. The second circuit 325 can comprise a controller 435 connected to the media 305 and the first circuit 320. When the first circuit 320 detects the condition, the first circuit 320 transmits a command to the controller 435. The command to the controller 435 causes the controller 435 either to format the media 305 and/or overwrite the data stored on the media 305, responsive to receiving the control signal indicating detection of the condition.

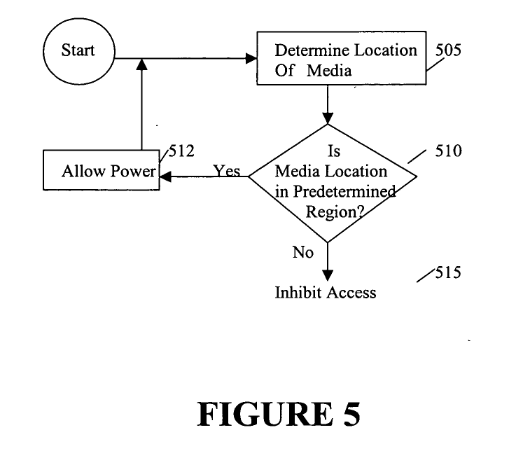

Referring now to FIG. 5, there is illustrated a flow diagram for securing data stored on a media. At 505, a global position satellite enable circuit detects the location of media. At 510, a first circuit determines whether the location of the media is within a predetermined region. As long as the location of the media is within the predetermined location, the second circuit maintains 512 the connection allows the flow of power from the power distribution circuit to the motor and arm.

When the media is outside the predetermined region, the second circuit inhibits 515 the flow of power from the power distribution circuit to either the arm and/or motor, thereby disabling access to the data. The second circuit can also 515 format or overwrite the media.

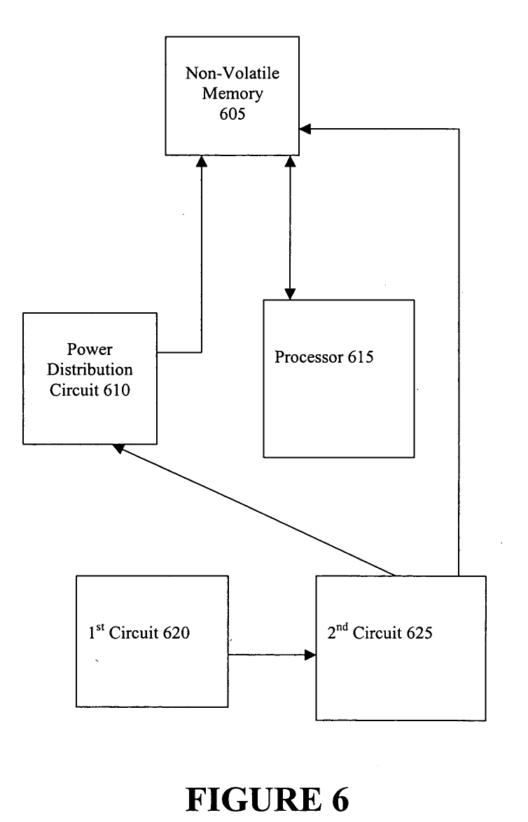

Referring now to FIG. 6, there is illustrated a mobile phone 600 in accordance with an embodiment of the present invention. The mobile phone 600 contains user data in non-volatile memory 605. The non-volatile memory 605 can comprise, for example, Flash memory. The mobile phone also comprises a power distribution circuit 610, a processor 615, a first circuit 620, and a second circuit 625. The non-volatile memory 605 is connected to the processor and the power distribution circuit. The non-volatile memory 605 can be an integrated circuit that is accessible by data and address pins. The first circuit 620 is operable to detect a condition. The second circuit 625 is connected to the first circuit, the power distribution circuit 610, and at least a portion of the non-volatile memory 605. The second circuit 625 selectively prevents or allows distribution of power from the power distribution circuit 610, based on detection of the condition, which powers the non-volatile memory 605 and thereby disables access to the user data.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A memory system for storing and securing data, said memory system comprising:
a media for storing the data;
a first circuit for detecting a condition; and
a second circuit for disabling access to the data, after detection of the condition.

2. The memory system of claim 1, wherein the condition is indicative of a location of the memory system.

3. The memory system of claim 2, wherein detecting the condition further comprises:
detecting whether a radio signal is received or not received by the first circuit.

4. The memory system of claim 3, wherein detecting the condition further comprises:
detecting the location of the media; and
detecting whether the location of the media is within a predetermined location.

5. The memory system of claim 1, wherein the first circuit comprises:
a receiver for detecting whether a particular radio signal is received or not received.

6. The memory system of claim 1, wherein the first circuit further comprises:
a global positioning system (GPS) circuit for detecting the location of the media; and
wherein the first circuit determines whether the location of the media is within a predetermined region.

7. The memory system of claim 1, wherein disabling access to the data, further comprises:
disconnecting power to at least a portion of the memory system.

8. The memory system of claim 7, further comprising:
a motor for rotating the media; and
wherein the at least a portion of the memory system comprises the motor.

9. The memory system of claim 7, further comprising:
an arm for reading the data from the media; and
wherein the at least a portion of the memory system comprises the arm.

10. The memory system of claim 1, wherein the second circuit comprises a controller for formatting the media after the first circuit detects the condition.

11. The memory system of claim 1, wherein the second circuit comprises a controller for overwriting the data after the first circuit detects the condition.

12. The memory system of claim 1, further comprising:
a casing for housing the media, the first circuit, and the second circuit.

13. A method for protecting data stored on media, said method comprising:
detecting a condition; and
preventing access to the data, after detecting the condition.

14. The method of claim 13, wherein the condition is indicative of a location of the media.

15. The method of claim 14, wherein detecting the condition further comprises:
detecting whether a radio signal is received or not received.

16. The method of claim 14, wherein detecting the condition further comprises:
detecting the location of the media; and
detecting whether the location of the media is within a predetermined location.

17. The method of claim 13, wherein disabling access to the data, further comprises:
disconnecting power to at least a portion of the media.

18. The method of claim 17, wherein the at least a portion of the media comprises:
a motor for rotating the media.

19. The method of claim 17, wherein the at least a portion of the media comprises:
an arm for reading data from the media.

20. The method of claim 13, wherein disabling access to the data further comprises:
formatting the media.

21. The method of claim 13, wherein disabling access to the data further comprises:
overwriting the data on the media.

22. The method of claim 13, wherein disabling access to the data further comprises:
destroying the media.

23. The method of claim 22, wherein destroying the media further comprises:
passing an electric current through the media.

24. The method of claim 22, wherein destroying the media further comprises:
increasing the temperature of the media.

25. A computer system for processing data, said computer system comprising:
a power distribution circuit;
a processor;
a hard disc drive connected to the processor and the power distribution circuit, said hard disc comprising:
media;
a motor connected to the media;
an arm located proximately to the media;
a first circuit operable to detect a condition; and
a second circuit connected to the first circuit, the power supply, and at least a portion of the hard disc, wherein the second circuit selectively prevents or allows distribution of power from the power distribution circuit, based on detection of the condition.

26. The computer system of claim 25, wherein the at least a portion comprises the arm.

27. The computer system of claim 25, wherein the at least a portion comprises the motor.

28. The computer system of claim 25, wherein the second circuit comprises a relay, and wherein the first circuit controls the relay.

29. The computer system of claim 25, wherein the first circuit comprises:
a receiver, said receiver operable to determine whether a particular radio signal is received or not received.

30. The computer system of claim 25, wherein the first circuit further comprises:
a global positioning system(GPS) circuit operable to detect the location of the media; and
wherein the first circuit determines whether the location of the media is within a predetermined region.
